(19) United States
(12) Patent Application Publication
(10) Pub. No.: US 2012/0085634 A1
(43) Pub. Date: Apr. 12, 2012

(54) DRY CLEANING SOLVENT

(75) Inventors: James E. Douglas, El Dorado Hills, CA (US); Wolf-dieter R. Berndt, Reno, NV (US)

(73) Assignee: GREENEARTH CLEANING, LLC, Sacramento, CA (US)

(21) Appl. No.: 13/268,250

(22) Filed: Oct. 7, 2011

Related U.S. Application Data
(60) Provisional application No. 61/391,437, filed on Oct. 8, 2010.

(51) Int. Cl. C11D 7/60; D06F 43/08; B01D 3/10; B01D 3/02; D06F 29/00; D06F 39/10

(52) U.S. Cl. 202/185.1; 510/285; 68/18 F; 202/205

(57) ABSTRACT

Described herein is a solution for use in cleaning articles comprising, a dry cleaning agent, wherein the dry cleaning agent comprises a siloxane solvent, a hydrocarbon solvent or a combination thereof, and an enhancer, which raises a KBV value of the solution. The enhancer can be soluble in the dry cleaning agent and water. Also described herein is a dry cleaning system that utilizes the solution, as well as a purification system for purifying the solution.

### CROSS-REFERENCE TO RELATED APPLICATIONS

This application claims priority to U.S. Provisional Application No. 61/391,437, Attorney Docket No. 503462, filed Oct. 8, 2010, titled “Dry Cleaning Solvent.” The contents of any patents, patent applications, and references cited throughout this specification are hereby incorporated by reference in their entireties.

### BACKGROUND OF THE INVENTION

Dry cleaning as an industry throughout the world has been under close scrutiny from both environmental and health standpoints. In the United States, the number of dry cleaners has decreased from over 40,000 in the 1990's to less than 28 thousand now. The traditional chemical used in dry cleaning is perchloroethylene solvent “PERC.” At one time over 85% of the dry cleaners in the United States were using PERC. That percentage has been steadily decreasing because of regulations and rules mandating the development of alternative solvents that are more environmentally acceptable and do not present the health risks associated with PERC.

In 1993 a Class III-A hydrocarbon was introduced to the dry cleaning industry. Since that time there have been several hydrocarbons introduced by other manufacturers. The characteristics of these hydrocarbons is that they have flash points ranging from 140° F. to 200° F.; thus, they are categorized as Class III-A solvents and have boiling points that require the use of a vacuum still. This makes it necessary to use new machines capable of operating safely with these hydrocarbons.

In 1999 siloxane solvents were developed. The siloxane most commonly in use is decamethylcyclopentasiloxane (D-5), known as “GreenEarth.” GreenEarth has similar characteristics as hydrocarbons such as high boiling points which require distillation through the use of a still with a vacuum applied, and a flash point of 170° F. The dry cleaning machines that were developed for hydrocarbons were almost compatible with D-5. However, due to the density similarities between D-5 and water, special equipment was developed to accomplish separation after cleaning so that the solvent could be reused. Table I (below) is a chart which compares the properties of PERC, GreenEarth, and Hydrocarbon.

TABLE I

| Characteristics | PERC (old std.) | GreenEarth D-5 | Hydrocarbon |
|---|---|---|---|
| KBV | 90+ | 13 | 27 |
| FLASH POINT | NONE | 170 F. | 142 F. TO 147 F. |
| DENSITY | 13.5 LBS/ | 7.95 LBS/ | 6.9 LBS/ |
| | GALLON | GALLON | GALLON |
| OIL MISIBLE | YES | YES | YES |
| H₂O IN | 105 PPM | 250 PPM | <100 PPM |
| SOLVENT | | | |

All three of these solvent alternatives are still in use throughout the industry. PERC is still the most widely used solvent, followed by hydrocarbon and then by GreenEarth.

PERC also has the most aggressive solvency on the market, which is reflected by the KBV (Kari Butnoyl Value) of 90+. While this relatively high value enables the solvent to more quickly and completely remove oil based stains, it also restricts its use from textiles that include certain dyes, plasticizers, and compositions which can be degraded by the solvent. PERC is also categorized as a HAP (hazardous air pollutant), a TAC (toxic air contaminant) and is listed on Prop 65 in California. In a growing number of states and countries, Perc is being eliminated as a viable solvent.

Hydrocarbon, as the next most used dry cleaning solvent, typically has a flash point in the range from 140° F. to 170° F. The KBV of hydrocarbon ranges between 27 and 37 for low flash points. These low KBV values limit the solvent's ability to remove oil based stains but do expand the types of garments that can be cleaned without as much concern for dyes and composition. Hydrocarbons are categorized as a VOC (volatile organic compound); this category is a growing concern for many regulatory agencies as the air quality is influenced by VOCs.

GreenEarth silicone is the next most widely used dry cleaning solvent in the world. With a flash point of 170° F., GreenEarth dry cleaning facilities are safer than others because during operation, the vapor laden air systems do not reach or exceed the 170° F. flashpoint of the solvent. Because the KBV of D-5 is 13, there are limitations in attempting to remove oil based stains, but there is little concern for dyes and construction of textiles. D-5 is VOC exempt in the United States and thus is reviewed by the environmentalist as a non-hazard. Cleaning is greatly improved due to the low surface tension which is 18 dynes.

### SUMMARY

The present invention is defined in the claims set forth following this disclosure. In some embodiments, the invention is a dry cleaning solution that includes a dry cleaning agent. The agent could be a siloxane or hydrocarbon solvent, or a combination of a siloxane and hydrocarbon, combined with an enhancing agent. The enhancer raises a KBV value of the solution to a desired degree. In the siloxane solvent embodiments, either cyclic or linear siloxane can be used. The enhancer, in embodiments, is an alcohol. In more specific embodiments, the enhancer is from the methyl alcohol group. Two methyl alcohols in particular that have been shown to be effective are 3-Methoxy-3-methyl-1-butanol (“MMB”), and 3-Methyl-1-3 butanediol (“IPG”). These solvents, in embodiments, can be used separately or together as the enhancer in the solution.

For example, in embodiments, the KBV of the solution can be increased into a range of 20 KBV to 400 KBV depending on the amount and type of enhancer added. Additionally, in embodiments, the flash point of the solution can be raised above 200° F. which results in being classified as Class IV solvent. Further, the added enhancer improves the efficiency of hydrotrope, increasing the solubility of slightly soluble organic compounds.

Accordingly, in one embodiment, provided herein is a solution for use in cleaning articles comprising: a dry cleaning agent, wherein the dry cleaning agent comprises a siloxane solvent, a hydrocarbon solvent or a combination thereof; and an enhancer. In one embodiment of the solution, the enhancer raises a KBV value of the solution. In another embodiment, the siloxane solvent includes one of: (i) a cyclic siloxane, and (ii) a linear siloxane.

The enhancer can be any composition that increases the KBV value of the solution, i.e., the KBV value of the siloxane solvent or hydrocarbon solvent. The enhancer can be miscible in water and in the dry cleaning agent. In one embodiment, the enhancer is an alcohol, e.g., an alcohol from the methyl alcohol group. Specific, non-limiting examples of alcohols include 3-Methoxy-3-methyl-1-butanol (“MMB”) or 3-Methyl-1-3 butanediol (“IPG”). In an embodiment, the enhancer includes both MMB and IPG.

In another embodiment, the cleaning agent is a siloxane solvent. In another embodiment, the cleaning agent is a hydrocarbon. In yet another embodiment, the cleaning agent is D-5.

The solution described can be used in a variety of systems. In embodiments, the solution is used in a dry cleaning system that has a container for the articles to be cleaned, e.g., a basket or wheel type arrangement, a vessel for the solution, a system for separating the solution from impurities during and after cleaning, and a pump coupled to the container. In embodiments the filter can be a regenerative filter using a filter medium, or a cartridge filter. In embodiments, impurities can be removed based on particle size, polar and non-polar properties, dye stuffs, and odoriferous impurities. The filtration can be accomplished both by adsorption and absorption.

Accordingly, in one aspect, provided herein is a system adapted for dry cleaning articles using a solution which includes a dry cleaning agent comprising a siloxane solvent, a hydrocarbon solvent, or a combination thereof, and an enhancer which is miscible in water and in the dry cleaning agent, the system comprising: a container for the articles; a vessel for the solution; a filter for separating the solution from impurities during and after cleaning; and a pump coupled to the container, the pump adapted to deliver a quantity of the solution from the container to the filter.

In one embodiment of this system, the filter is one of a (i) regenerative filter using a filter medium, and (ii) a cartridge filter. In another embodiment, the container is either a basket or a wheel arrangement.

In another aspect, provided herein is a purification system for the purification of a used dry cleaning solution, the solution including (i) water; (ii) a first cleaning component comprising a siloxane solvent, a hydrocarbon solvent, or a mixture thereof; (iii) a second cleaning component which is an enhancer which is soluble into both water and the first cleaning component, the purification system comprising: a distilling system adapted to remove water from the used dry cleaning solution at ambient atmospheric conditions and divert the water for one of reuse, storage, and disposal; and a vacuum administrating system used in distilling the first and second cleaning components from the used dry cleaning solution in a vacuum and diverting the first and second cleaning components for one of reuse and storage. The enhancer, in embodiments, is an alcohol. In more specific embodiments, the enhancer is from the methyl alcohol group. The enhancer can be 3-Methoxy-3-methyl-1-butanol (“MMB”) or 3-Methyl-1-3 butanediol (“IPG”), or combinations thereof.

In one embodiment of the purification system, the used dry cleaning solution is recovered during a drying process in a separate vessel and is directed to the distilling system for the purpose of separating the water and other low end boilers from high end boilers, the high-end boilers including the first and second cleaning components. In another embodiment, the distilling system heats the used dry cleaning solution at an ambient atmosphere at temperatures in excess of 212° F. in order to remove a water vapor and other low end boiler vapors.

In still another embodiment, the system further comprises a first condenser for returning the water vapor to a liquid and a receiving container for receiving and holding the liquid water. In yet another embodiment, the vacuum administering system is adapted to generate a vacuum and maintain temperatures up to 300 F in order to remove a vapor including the first and second cleaning components along with any other high end boilers. The system can comprise a second condenser for returning the vapor including the first and second cleaning components to a liquid and a receiving container.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 contains a schematic functional block diagram of a dry cleaning system and process according to exemplary embodiments.

FIG. 2 contains a schematic functional block diagram of a dry cleaning system and process according to other exemplary embodiments.

### DETAILED DESCRIPTION

Embodiments of the present invention provide compositions, solutions, systems and methods for cleaning articles. More specifically, in embodiments, for dry cleaning fabrics. Although the dry cleaning industry has taken directions to use alternative solvents to substitute the process of cleaning with PERC, there have been limitations that alternative cleaning processes present. The lack of a high KBV values associated with GreenEarth silicones or hydrocarbon solvents have made the removal of oil based stains more difficult, expensive and time consuming. The inability of these solvents to be made miscible in water does not allow hydrophilic (water) based stain removal.

Many cleaning processes are now water-based processes due to the environmental and safety concerns of using PERC, previously the only viable solvent with a high KBV. It has also been discovered that that separation of water from solvents in the cleaning process is also very critical. Water will always be introduced to the cleaning system due to the relative humidity and from pre-spotting with water based spotters. Too much water will cause dye bleeding, possible shrinkage of garments, and an environment for bacterial growth which can result in odor.

In one embodiment, the present invention is directed to a system and method for dry cleaning articles using a siloxane solvent as the primary solvent. Organo-silicones useful with the present invention include cyclic siloxane and/or linear siloxane used as a primary solvent which is enhanced with one or more additional component. Siloxanes that could be used in the instant invention are also described in U.S. Pat. No. 6,042,618, titled Dry Cleaning Method and Solvent, issued Mar. 28, 2000, the entire contents of which are incorporated herein by reference. Of these siloxanes, decamethyl-cyclopentasiloxane, a pentamer commonly referred to as D5, is presently preferred.

The additional component, in embodiments, are enhancers which may be miscible both in water and into the siloxane solvent. These dually-miscible enhancers, in still further embodiments, are derived from an alcohol. In more specific embodiments, one or more alcohols are selected from the methyl alcohol group. Some examples of enhancing dually-miscible additional components which have proved especially useful alone or in combination are: (i) 3-Methoxy-3-methyl-1-butanol (“MMB”) which has a CAS #: 56539-66-3 and/or (ii) 3-Methyl-1-3 butanediol (“IPG”) also known as “isoprene glycol” which has a CAS #: 2568-33-4.

Another embodiment of the present invention is a system and method for dry cleaning articles using an enhanced hydrocarbon solvent. The additional component used in embodiments to enhance the primary hydrocarbon solvent, like with the earlier embodiment, may be miscible both in water, and into the primary hydrocarbon solvent used. In embodiments, the dually miscible enhancer is derived from the field of alcohols. In some more specific embodiments from the methyl alcohol group. Some examples of additional components which might be used as the dually miscible enhancer are: (i) 3-Methoxy-3-methyl-1-butanol (“MMB”) which has a CAS #: 56539-66-3 and/or (ii) 3-Methyl-1-3 butanediol (“IPG”) also known as “isoprene glycol” which has a CAS #: 2568-33-4).

Because both hydrocarbon and silicones have low KB Values they do not allow for the best removal of hydrophobic stains. In addition the solvents are not miscible with water, and thus, the removal of hydrophilic stains is extremely difficult. It has been found that with the addition of the enhancing components, or mixtures thereof, both the KB Value and the miscibility in water are greatly improved. Below in Table II are the relevant properties of two preferred additional components, MMB and IPG:

TABLE II

| CHARATERISTICS | MMB | IPG |
|---|---|---|
| K.B.V. | 400+ | 210 |
| FLASH POINT | 154.4° F. | 240.8° F. |
| DENSITY | 7.69 LBS/GALLON | 8.04 LBS/GALLON |
| BOILING POINT | 345.2 | 397.4 |
| OIL MISCIBLE | TOTAL | TOTAL |
| WATER MISCIBLE | TOTAL | TOTAL |
| V.O.C. | YES | NO |

It has been found that alcohols, such as MMB (3-Methoxy-3-methyl-1-butanol, CAS #: 56539-66-3) and IPG (3-Methyl-1-3 butanediol, CAS #: 2568-33-4), impart greater performance values to both silicones and hydrocarbons.

The dually-miscible enhancers used herein, when added in differing ratios, can elevate the KBV to a desired level. This level can be manipulated by increasing or decreasing the percentage of the additional enhancers used relative to the primary solvent (siloxane or hydrocarbon). For example, by adding MMB to the siloxane solvent so that the overall weight percentages are 70% silicone and 30% MMB, the KBV is elevated from 20 or less to 50. And by manipulating the ratio of primary solvent to the additional enhancing component, the KBV can be adjusted to provide the desired KBV level. For example, for attacking the most difficult oil-based stains on durable fabrics, the proportion of the additional component (e.g., MMB, IPG, or a mixture thereof) may be increased to a level such that the enhancing component(s) comprises nearly 100% by volume of the solution. Thus, the percentage of additional component or mixture thereof in the total solution may range from about 5% to 99% (w/w) for effective dry cleaning of different types of materials having different levels of staining and compatibility. In one embodiment, the weight percentage of the additional component or mixture thereof in the total solution is about 20% to 80%, about 30% to 70%, or about 40% to 60%. This improvement is very useful for industrial cleaning operations which depend on the aggressively of the high KBV PERC to clean oily work-wear. With a higher concentration of the enhancing component, either siloxane or hydrocarbons can process work-wear with more effectiveness than can be accomplished with traditional water processes.

Where delicate fabrics are involved and the same KB values are needed, the percentage by weight of the enhancing component relative to the primary solvent (siloxane or hydrocarbon) could be reduced. These embodiments provide a slight KBV kick that improves oil-based stain removal, but remains below the values which might harm the more delicate fabrics involved.

Another aspect of the invention is the discovery of the enhancing component's ability to better remove hydrophilic type stains. Since the enhancing additional components are miscible in both the solvents and water, the solution is capable of removing water soluble stains. This dual miscibility of the enhancing component—into both the water and the primary solvent—provides great benefits. For example, time is saved because less human intervention required to chemically spot-treat the products.

In the embodiments where siloxane is the primary solvent, the inclusion of the enhancing component does not create compatibility problems for dyes. This is because the siloxane is inert with a very low surface tension, thus protecting most fibers and dyes from the higher KB values of the additional component, and thus, the bleeding of the dyes.

The fabrics and dyes are similarly protected from the adverse effects of water. The separation of water from solvent is important in the cleaning process. Too much water will result in a dry cleaning system that will results in a damaged garment by way of dyes running and garments shrinking. Again, when siloxane are used as the primary solvent, Having a low KB value and low surface tension dye running and garment shrinking is greatly reduced.

Methods and systems for separating the primary solvent, enhancing component, and water after use in cleaning are also included herein. It has been discovered that the separation of both silicone and hydrocarbon when mixed with ratios of enhancers is most challenging. Ideally the water build up in the system used makes it difficult to retain the enhancer. Especially considering that (i) the enhancer is miscible in both the water and the primary solvent used, and (ii) that the densities of all three solution components are very close.

TABLE III

| | | SILICONE, | | | |
|---|---|---|---|---|---|
| CHARACTERISTICS | WATER | D-5 | HYDROCARBON | MMB | IPG |
| DENSITY | 8.33 LBS/ | 7.95 LBS/ | 6.7 LBS/ | 7.69 LBS/ | 8.04 LBS/ |
| | GAL | GAL | GAL | GAL | GAL |
| BOILING | 212 F. | 410 F. | 376 F. TO | 345.2 F. | 397.4 F. |
| POINT | | | 401 F. | | |

As can be seen for the component embodiments shown in Table III above, the densities of (i) water; (ii) the primary components D-5 and/or Hydrocarbon; and (iii) the enhancing components MMB and/or IPG, all fall between 6.5 and 8.04 lbs. per gallon. This closeness makes it difficult to rely only on density differences (e.g., by using gravity) for settling or separation. Since pure hydrocarbon solvent at 6.7 lbs./gal. has the greatest density difference from the density of water (8.33 lbs./gal.), for the embodiments using hydrocarbon as the primary solvent, the greater density difference allows water separation to occur by the use of gravity.

The presence of water in the dry cleaning systems cannot be avoided due to the relative humidity in the air and on the garments, and also the fact that pre-spotting with water based spotters is often necessary. The separation of water and solvent has always been a challenge. When working with Perc the density difference of water and Perc is so great that gravity separation can be easily utilized. Because Perc also boils at a low temperature a distillation system does not require a vacuum.

Due to the density differences between hydrocarbon and water, gravity separation can normally be used successfully. Hydrocarbon and water have a high Henry's Law Constant and thus because they repel each other the separation is also enhanced. The boiling point of hydrocarbon is such that a vacuum is required for distillation.

The same holds true for silicone in terms of it being physically separable from water, but because the density difference is so close, special techniques were developed so that a system would accomplish the desired separation. See, e.g., U.S. Pat. No. 6,059,845, the contents of which are herein incorporated by reference.

The use of the enhancers changes this. When the enhancer (which is dually miscible into water and the primary solvents) is introduced to either the hydrocarbon or silicone, then the water goes into a soluble solution. This makes the separation of the enhancer from the water more challenging. During the drying process of garments that have been cleaned, water, solvents and the enhancer are being recovered in a solution that is very difficult to separate. This can be overcome by directing the solution that is recovered during drying to a distillation process.

According to the invention, this separation problem has been solved using a two-stage distillation process. First, an initial distillation is done at an ambient state at temperatures greater than 212° F. to separate the water and any other low end boilers. The water and low end boilers are distilled off first, and then condensed. Once in condensed form, the recovered water and low end boilers are redirected to a vessel, or otherwise disposed of, and can either be discarded or reused for some purpose. The distilled recovery is redirected in this manner until the entire water distillate has been condensed and separately disposed of.

After the low end boilers and water are removed, a second stage of the distillation process begins. After temperatures have been maintained in excess of 212° F. for a sufficient amount of time, then a vacuum is initiated. Hydrocarbons, silicones and enhancers with higher boiling points will not distill until a vacuum is applied. But under vacuum and at the elevated temperatures, the primary solvent and enhancers boil, are condensed, and are then directed back to the dry cleaning machine for reuse, or delivered to a vessel for storage.

In one embodiment, a single condenser is used for both the ambient and vacuum stages of the distillation process. The single condenser is drained to one path after the water is distilled at ambient pressure. Then, after the water has been removed, the silicones (or hydrocarbon) and enhancers are distilled under vacuum, are condensed, and are directed to another path after they have been separated.

Alternatively, two separate condensers could be used for each of the ambient and vacuum stages of the process.

Also a part of the overall system in embodiments, a purification system is provided. The purification system, in embodiments, reclaims (i) water; (ii) the siloxane solvent (or hydrocarbon solvent); and (iii) the water-soluble enhancer. It uses a distilling system which is adapted to remove the water from the used solution at ambient atmospheric conditions and divert the water for one of reuse or disposal/waste. In more specific embodiments, the distilling system heats the used solution which may have been directed to the still from the working system or from the drying process.

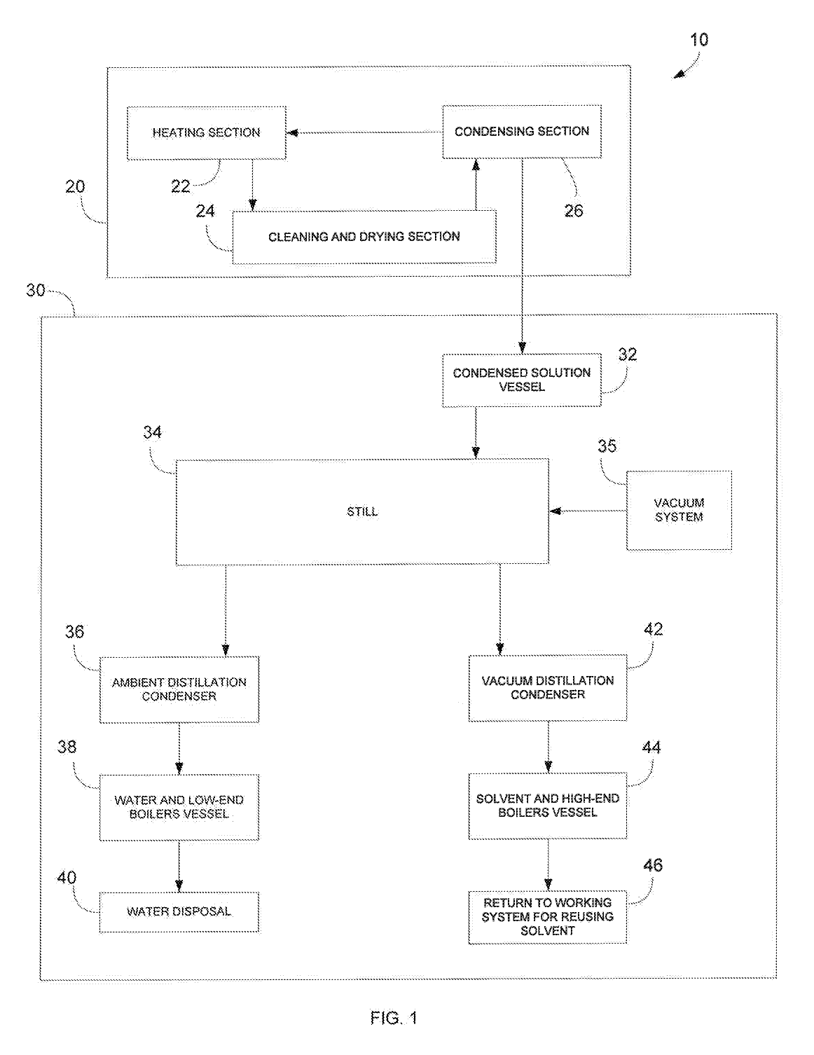

FIG. 1 contains a schematic functional block diagram of a dry cleaning system and process according to exemplary embodiments. Referring to FIG. 1, the dry cleaning system and process 10 includes a cleaning and drying subsystem and process 20 and a fluid recovery and disposal subsystem and process 30. In some exemplary embodiments, the cleaning and drying subsystem and process 20 includes an air system which includes a fan, heating coils, condensing coils and a lint filtration system. The air system heats and circulates air around the cleaning and drying subsystem and process 20 as indicated by the air flow arrows in FIG. 1. Generally, the cleaning and drying subsystem and process 20 includes a heating section 22, a cleaning and drying section 24 and a condensing section 26, which circulate the air as indicated by the air flow arrows in the figure. In certain embodiments the air system can be remotely located relative to the cleaning basket and acts as a transfer system for drying. This configuration allows for more throughput of items being cleaned, since the drying and recovery processes are the time consuming aspects of dry cleaning.

During the drying process, water, solvents and enhancers are volatized through the application of hot air in the heating section 22. As shown in FIG. 1, the air and vapors flow through the heating section 22 and then through the cleaning and drying drum section 24 and then through the condensing section 26. As the vapors are condensed in the condensing section 26, the liquid condensate is directed to the condensed solution vessel 32 in the fluid recovery and disposal subsystem and process 30. Normal operation allows for separation of water from a solvent at this stage. However, this is not possible as the enhancer is miscible in the water. According to the disclosure, the solution is directed to the fluid recovery and disposal subsystem and process 30.

The fluid recovery and disposal subsystem and process 30 includes the condensed solution vessel 32, which receives the condensate from the condensing section 26. The still 34 distils the condensate. A vacuum system 35 is coupled to the still 35 to reduce the pressure in the still during distillation, under certain circumstances as described below in detail. The vacuum system 35 can be, for example, a liquid ring pump, a venturi-based system, or similar device.

The still 34 is connected to an ambient distillation condenser 36. In the initial phase of distillation, the solution is heated and the vapors are condensed in the ambient distillation condenser 36 at an ambient pressure. This directs the water and low-end boilers to the ambient and low-end boilers vessel 38. The water from this vessel 38 can be manually drained or sensed by electrical conductivity and drained for water disposal 40. In some exemplary embodiments, the vacuum system 35 is then used for distilling the siloxane solvent (or hydrocarbon solvent) and the enhancer that require distillation in a vacuum condition. The vapors from this second-stage distillation are condensed in the vacuum distillation condenser 42, and the condensate from this condensation is directed to the solvent and high-end boilers vessel 44. The fluids from this vessel 44 can then be redirected to the working system for reuse, as indicated at 46. In some exemplary embodiments, the vacuum system 35 and still 34 generate a vacuum and maintain temperatures up to 300° F. in order to remove the vaporous solvents and other high end boilers. The solvents are then condensed and reused. Thus, the different components of the solution, e.g., water and solvents, can be separated based on boiling points and the use of vacuum, and recycled.

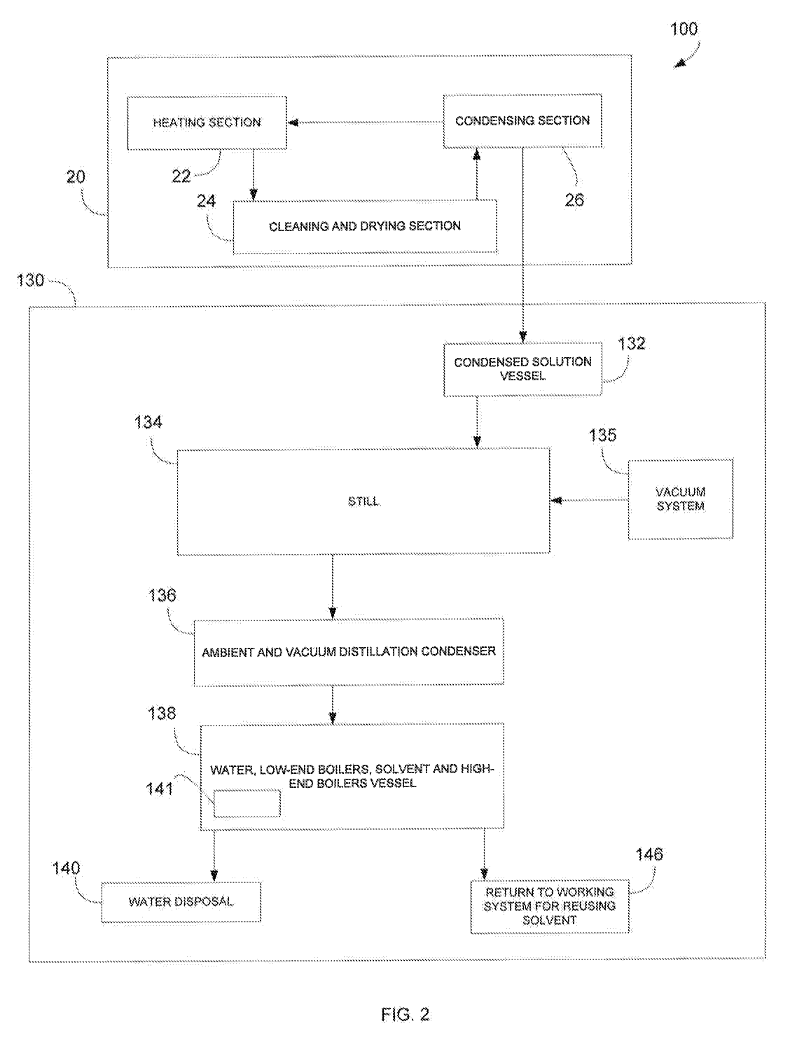

FIG. 2 contains a schematic functional block diagram of a dry cleaning system and process according to other exemplary embodiments. The difference between the embodiments of FIG. 1 and the embodiments of FIG. 2 is that in the embodiments of FIG. 2, a single condenser 136 is used to condense the vapors recovered in both stages of the two-stage distillation process, instead of the two separate condensers 36 and 42 used in the embodiments of FIG. 1. A single vessel 138 is also used in the embodiments of FIG. 2, instead of the two vessels 38 and 44 used in the embodiments of FIG. 1. Elements of the embodiments of FIG. 2 that are the same as those of the embodiments of FIG. 1 are identified by like reference numerals. Detailed description of these like elements will not be repeated.

Referring to FIG. 2, the dry cleaning system and process 100 includes the cleaning and drying subsystem and process 20 and a fluid recovery and disposal subsystem and process 130. The condensate from the condensing section 26 is directed to the condensed solution vessel 132 in the fluid recovery and disposal subsystem and process 130. The fluid recovery and disposal subsystem and process 130 includes the condensed solution vessel 132, which receives the condensate from the condensing section 26. The still 134 distils the condensate. A vacuum system 135 is coupled to the still 134 to reduce the pressure in the still 134 during the second-stage distillation. The vacuum system 135 can be, for example, a liquid ring pump, a venturi-based system, or similar device.

The still 134 is connected to an ambient and vacuum distillation condenser 136. In the initial phase of distillation, the solution is heated and the vapors are condensed in the ambient and vacuum distillation condenser 136 at an ambient pressure. This directs the water and low-end boilers to the water, low-end boilers, solvents and high-end boilers vessel 138. The water from this vessel 138 can be manually drained for water disposal 140. Alternatively, the water, low-end boilers, solvents and high-end boilers vessel 138 may include a water sensor 141, which by detecting electrical conductivity can detect water in the vessel 138. If water is detected at any time, i.e., before, during or any time after the first stage of distillation, the water sensor 141 can open a valve to allow water to drain for water disposal 140.

In some exemplary embodiments, the vacuum system 135 is then used for distilling the siloxane solvent (or hydrocarbon solvent) and the enhancer that require distillation in a vacuum condition. The vapors from this second-stage distillation are condensed in the ambient and vacuum distillation condenser 136, and the condensate from this condensation is directed to the water, low-end boilers, solvents and high-end boilers vessel 138. The fluids from this vessel 138 can then be redirected to the working system for reuse, as indicated at 146. In some exemplary embodiments, the vacuum system 135 and still 134 generate a vacuum and maintain temperatures up to 300° F. in order to remove the vaporous solvents and other high end boilers. The solvents are then condensed and reused. Thus, the different components of the solution, e.g., water and solvents, can be separated based on boiling points and the use of vacuum, and recycled.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and sub combinations are of utility and may be employed without reference to other features and sub combinations and are contemplated within the scope of the claims. Not all steps listed in the various figures need be carried out in the specific order described.

### EXPERIMENTAL

As discussed above, the dually-miscible enhancers used herein, when added in differing ratios, can elevate the KBV to a desired level. This level can be manipulated by increasing or decreasing the percentage of the additional enhancers used relative to the primary solvent (siloxane or hydrocarbon). For example, by adding MMB to the siloxane solvent D-5 so that the overall weight percentages are 70% D-5 and 30% MMB, the KBV is elevated from 20 or less to 50. And by manipulating the ratio of primary solvent to the additional enhancing component, the KBV can be adjusted to provide the desired KBV level. For example, for attacking the most difficult oil-based stains on durable fabrics, the proportion of the additional component (e.g., MMB, IPG, or a mixture thereof) may be increased to a level such that the enhancing component(s) comprises nearly 100% by volume of the solution. Thus, the percentage of additional component or mixture thereof in the total solution may range from about 5% to 99% (w/w) for effective dry cleaning of different types of materials having different levels of staining and compatibility.

The invention claimed is:

1. A solution for use in cleaning articles comprising:
a dry cleaning agent, wherein the dry cleaning agent comprises a siloxane solvent, a hydrocarbon solvent or a combination thereof; and
an enhancer.

2. The solution of claim 1 wherein the enhancer raises a KBV value of the solution.

3. The solution of claim 1 wherein the siloxane solvent includes one of: (i) a cyclic siloxane, and (ii) a linear siloxane.

4. The solution of claim 1 wherein the enhancer is an alcohol.

5. The solution of claim 1 wherein the enhancer is from the methyl alcohol group.

6. The solution of claim 1 wherein the enhancer includes at least one of: (i) 3-Methoxy-3-methyl-1-butanol (“MMB”); and (ii)) 3-Methyl-1-3 butanediol (“IPG”).

7. The solution of claim 6 wherein the enhancer includes both MMB and IPG.

8. The solution of claim 1 wherein the cleaning agent is a siloxane solvent.

9. The solution of claim 1 wherein the cleaning agent is a hydrocarbon.

10. The solution of claim 1 wherein the cleaning agent is D-5.

11. The solution of claim 1 wherein an amount of the enhancer is included which results in the KBV of the solution to be increased into a range of 20 KBV to 400 KBV.

12. The solution of claim 1 wherein an amount of enhancer is added to the solution such that a flash point is raised above 200° F.

13. The solution of claim 1 wherein the enhancer improves the efficiency of hydrotrope, increasing the solubility of slightly soluble organic compounds.

14. A system adapted for dry cleaning articles using a solution which includes a dry cleaning agent comprising a siloxane solvent, a hydrocarbon solvent, or a combination thereof, and an enhancer which is miscible in water and in the dry cleaning agent, the system comprising:
a container for the articles;
a vessel for the solution;
a filter for separating the solution from impurities during and after cleaning; and
a pump coupled to the container, the pump adapted to deliver a quantity of the solution from the container to the filter.

15. The system of claim 14 wherein the filter is one of a (i) regenerative filter using a filter medium, and (ii) a cartridge filter.

16. The system of claim 14 wherein the container is either a basket or a wheel arrangement.

17. A purification system for the purification of a used dry cleaning solution, the solution including (i) water; (ii) a first cleaning component comprising a siloxane solvent, a hydrocarbon solvent, or a mixture thereof; (iii) a second cleaning component which is an enhancer which is soluble into both water and the first cleaning component, the purification system comprising:
a distilling system adapted to remove water from the used dry cleaning solution at ambient atmospheric conditions and divert the water for one of reuse, storage, and disposal; and
a vacuum administrating system used in distilling the first and second cleaning components from the used dry cleaning solution in a vacuum and diverting the first and second cleaning components for one of reuse and storage.

18. The system according to claim 17 wherein the used dry cleaning solution is recovered during a drying process in a separate vessel and is directed to the distilling system for the purpose of separating the water and other low end boilers from high end boilers, the high-end boilers including the first and second cleaning components.

19. The system according to claim 17 wherein the distilling system heats the used dry cleaning solution at an ambient atmosphere at temperatures in excess of 212° F. in order to remove a water vapor and other low end boiler vapors.

20. The system according to claim 19 further comprising a first condenser for returning the water vapor to a liquid and a receiving container for receiving and holding the liquid water.

21. The system according to claim 17 where the vacuum administering system is adapted to generate a vacuum and maintain temperatures up to 300 F in order to remove a vapor including the first and second cleaning components along with any other high end boilers.

22. The system according to claim 21 further comprising a second condenser for returning the vapor including the first and second cleaning components to a liquid and a receiving container.
